(19) United States
(12) Patent Application Publication
(10) Pub. No.: US 2001/0007446 A1
(43) Pub. Date: Jul. 12, 2001

(54) Feed circuit for array antenna

(76) Inventor: Yoshihisa Amano, Tenri-shi (JP)

Correspondence Address: BIRCH STEWART KOLASCH & BIRCH, PO BOX 747, FALLS CHURCH, VA, 22040-0747, US

(21) Appl. No.: 09/758,365

(22) Filed: Jan. 12, 2001

(30) Foreign Application Priority Data
Jan. 4, 2000 (JP) 2000-006539

(51) Int. Cl. H01Q 21/00; H01Q 1/50

(52) U.S. Cl. 343/860; 343/816; 343/852

(57) ABSTRACT

A transmission line 2 to one end of which an electric signal is inputted has λ/4 transmission lines 3, 4 connected to the other end thereof. An element antenna la is connected to the other end of the λ/4 transmission line 3 via a transmission line 5, and an element antenna 1b is connected to the other end of the λ/4 transmission line 3 via a transmission line 6. An element antenna 1c is connected to the other end of the λ/4 transmission line 4 via a transmission line 7, and an element antenna 1d is connected to the other end of the λ/4 transmission line 4 via a transmission line 8. Impedances of the transmission lines 2-8 and the λ/4 transmission lines 3, 4 are set to 50 Ω, respectively.

### BACKGROUND OF THE INVENTION

The present invention relates to a feeder circuit for an array antenna intended to radiate or receive microwaves with a plurality of element antennas.

A normal antenna involves two essential components, a plurality of element antennas disposed regularly and a feeder circuit for feeding electric power to all the element antennas. The feeder circuit, one of these two components, is in many cases formed of high-frequency transmission lines print-patterned on a high-frequency circuit board, in which the high-frequency transmission lines are repeatedly branched from one input port, leading to a multiplicity of output ports (connected to element antennas).

Such a high-frequency transmission line, having an electrical property called characteristic impedance, needs to be designed carefully at branched points of the high-frequency transmission line. That is, when the high-frequency transmission line is branched without considerations for impedance matching, there would occur a reflection phenomenon of electrical signals due to impedance mismatching at the branched point, so that the electrical signals would not transfer normally. Thus, for feeder circuits for array antennas, normally, a known technique called λ/4 matching circuit is used as a means for impedance matching.

FIG. 11 shows a schematic diagram of the λ/4 matching circuit, where reference numeral 61 denotes a circuit having a characteristic impedance of Z₁₁ (high-frequency transmission line) and 62 denotes a circuit having a characteristic impedance of Z₁₂ (high-frequency transmission line). It is known that if a high-frequency transmission line 63 (hatched portion in FIG. 11) having a length of λ/4 (where λ is the wavelength of the electrical signal) is inserted between the two circuits 61 and 62, and if the characteristic impedance Z₁₃ of the λ/4 long high-frequency transmission line (hereinafter, referred to as λ/4 transmission line) 63 is set to:

Z₁₃=\sqrt{Z₁₁xZ₁₂} (Eq. 2)

then this circuit becomes impedance-matched so that the reflection phenomenon of electrical signals having a wavelength of λ no longer occurs, according to the high frequency circuit theory.

Now, with respect to a feeder circuit for an array antenna using this λ/4 matching circuit, it is described below what structure is adopted for implementation of impedance matching of branched points of the high-frequency transmission lines. Although an array antenna in which the number of element antennas is 4 (=2×2) will be discussed in the following description, the case is the same also with larger-scale array antennas. Although the element antennas of a 50 Ω input impedance system are discussed below, the case is the same also with array antennas of, for example, a 1000 Ω input impedance system. As an array antenna often involves weighting on the excitation strength of element antennas with a view to suppressing the side lobe radiation, both an array antenna without weighting and an array antenna with weighting applied are described below. As for the ratio of power distribution to the element antennas of the array antenna with weighting applied, a case of the simplest ratio of 1:2:2:4 is taken as an example, but the case is generally the same also with those of different distribution ratios.

FIG. 5 shows a plan view of a feeder circuit for array antennas without weighting applied. A transmission line 22 being to have an electric signal inputted at its one end, one end of a transmission line 26A is connected to the other end of the transmission line 22 via a λ/4 transmission line 25A (hatched portion in FIG. 5), while one end of a transmission line 26B is connected to the other end of the transmission line 22 via a λ/4 transmission line 25B (hatched portion in FIG. 5). It is noted here that λ is the wavelength of an electric signal on a microstrip line at the operating frequency of the array antenna. Further, one end of a transmission line 27 is connected to the other end of one transmission line 26A via a λ/4 transmission line 25C, while one end of a transmission line 28 is connected to the other end of the transmission line 26A via a λ/4 transmission line 25D. Also, one end of a transmission line 29 is connected to the other end of the other transmission line 26B via a λ/4 transmission line 25E, while one end of a transmission line 30 is connected to the other end of the transmission line 26B via a λ/4 transmission line 25F. Element antennas 21a, 21b, 21c, 21d are connected to the other ends of the transmission lines 27 to 30, respectively. The element antennas 21a- 21d and the feeder circuit are formed integrally by print patterning on a high frequency circuit board (not shown) formed of an insulating material such as ceramics. All of the transmission lines 22, 25A-25F, 26A, 26B, 27-30 are implemented by microstrip lines of a 50 Ω characteristic impedance system, while the four element antennas 21a- 21d are implemented by patch antennas. An electrical signal inputted to one end of the transmission line 22 is distributed through three bifurcated portions and thereafter fed to the element antennas 21a-21d at nearly equal amplitude and phase.

In FIG. 5, the λ/4 transmission lines 25A-25F are of the 71 Ω system, and these λ/4 transmission lines 25A-24F of the 71 Ω system are inserted at totally six places for the purpose of impedance matching.

FIG. 6 shows a high frequency equivalent circuit of the feeder circuit for array antennas shown in FIG. 5. At a plurality of points in the circuit, impedances as viewed toward the element antennas 21a-21d are expressed by dotted lines, arrows and numerical values. For an easier confirmation from the high frequency circuit theory, this feeder circuit is impedance-matched with the 50 Ω system.

Although an array antenna with 4 (=2×2) element antennas is adopted for the feeder circuit for array antennas of FIG. 5, a larger-scale array antenna can also be designed by repeating the same design method pattern as shown in FIG. 12. FIG. 12 illustrates the process of designing an array antenna having 16 (=4×4) elements based on the array antenna 20 having 4 (=2×2) elements shown in FIG. 5. That is, regarding each array antenna 20 having 4 (=2×2) elements surrounded by dotted line as one block, 4 (=2×2) blocks are connected to one another by the same impedance matching approach.

Indeed the feeder circuit for array antennas shown in FIG. 5 is impedance-matched, but there is a problem that the 71 Ω transmission lines 25A-25F become considerably thinner in line width than the other transmission lines. As another impedance matching approach other than that of FIG. 5, there has been available a feeder circuit for array antennas shown in FIG. 7. In this feeder circuit for array antennas, as shown in FIG. 7, a transmission line 32 being to have an electric signal inputted at its one end, each one end of transmission lines 33A, 33B is connected to the other end of the transmission line 32 via a λ/4 transmission line 34A (hatched portion in FIG. 7). One end of a λ/4 transmission line 34B is connected to the other end of one transmission line 33A, and each one end of transmission lines 35, 36 is connected to the other end of the λ/4 transmission line 34B. Element antennas 31a, 31b are connected to the other ends of the transmission lines 35, 36, respectively. Further, one end of a λ/4 transmission line 34C is connected to the other end of the other transmission lines 33B, and each one end of transmission lines 37, 38 is connected to the other end of the λ/4 transmission line 34C. Element antennas 31c, 31d are connected to the other ends of the transmission lines 37, 38.

In FIG. 7, the λ/4 transmission lines 34A-34C (hatched portions in FIG. 7) are 35 Ω system transmission lines. These λ/4 transmission lines 34A-34C of the 35 Ω system are inserted at totally three places for the purpose of impedance matching. FIG. 8 is a high frequency equivalent circuit for array antennas shown in FIG. 7. For an easier confirmation from the high frequency circuit theory, this high frequency equivalent circuit is impedance-matched with the 50 Ω system. However, in this feeder circuit for array antennas, there is a problem that the 35 Ω transmission lines 34A-34C are thicker in line width than the other transmission lines, converse to FIG. 5.

Next, FIG. 9 shows a plan view of a feeder circuit for array antennas with weighting applied for suppression of the side lobe. A transmission line 42 being to have an electric signal inputted at its one end, one end of a transmission line 43 is connected to the other end of the transmission line 42 via a λ/4 transmission line 46A (hatched portion in FIG. 9). One end of a λ/4 transmission line 46B is connected to the other end of the transmission line 43. An element antenna 41a is connected to the other end of the λ/4 transmission line 46B via a transmission line 49, and an element antenna 41b is connected to the other end of the λ/4 transmission line 46B via a λ/4 transmission line 44A (hatched portion in FIG. 9) and a transmission line 50. On the other hand, one end of a λ/4 transmission line 48 (hatched portion in FIG. 9) is connected to the other end of the λ/4 transmission line 46A, and one end of a λ/4 transmission line 47 (hatched portion in FIG. 9) is connected to the other end of the λ/4 transmission line 48. An element antenna 41c is connected to the other end of the λ/4 transmission line 47 via a transmission line 51. An element antenna 41d is connected to the other end of the λ/4 transmission line 47 via the λ/4 transmission line 44A (hatched portion in FIG. 9) and a transmission line 52. In FIG. 9, the λ/4 transmission lines 44A, 44B are 35 Ω system transmission lines, the λ/4 transmission lines 46A, 46B are 29 Ω system transmission lines, the λ/4 transmission line 47 is a 20 Ω system transmission line and the λ/4 transmission line 48 is a 25 Ω system transmission line.

FIG. 10 is a high frequency equivalent circuit of the array antenna shown in FIG. 9, where it can indeed be seen that impedance matching is obtainable. As shown in FIG. 10, in the feeder circuit for the array antenna of FIG. 9, impedances as viewed at the output sides of the individual parts of the circuit are nonuniform among the four paths to which currents are distributed. Since the current flow increases with decreasing impedance, the distribution ratio of currents is controlled by intentionally making the impedances nonuniform.

However, the feeder circuits for array antennas shown in FIGS. 5, 7 and 9 have the following problems (1) and (2):

(1) Lengths L₁, L₂, L₃ (distances from the first branch to the succeeding branch as viewed from the input side) shown in FIGS. 5, 7 and 9 are normally designed so as to be much larger than the lengths of the λ/4 transmission lines because the circuits are complex so that a large space is necessary for their layout, as a result, these feeder circuit are unsuitable for miniaturization. The term, miniaturization, refers to a case in which the intervals of a plurality of element antennas constituting an array antenna are narrowed so that the area of the array antenna as a whole is reduced while the individual element antennas remain the same size.

(2) In the case where thin transmission lines are involved, the patterning for substrate wiring results in worse yields, so that resistance components of the wiring comes to a significant level, leading to increased loss of electric signals. Meanwhile, thick transmission lines would cause parasitic electrical characteristics to occur in high frequency circuits of, particularly, milliwave band.

These problems (1), (2) would become more significant in the case of the array antenna shown in FIG. 9, in which weighting for side lobe suppression is applied, compared with the array antennas shown in FIGS. 5 and 7, in which weighting is not applied.

The problem (2) (line width problem), which would be somewhat difficult to understand, is explained in detail below.

First, as a high frequency circuit, a most common ceramic substrate having a thickness of 0.15 mm and a dielectric constant of 9.8 is used. In this case, the line widths of the transmission lines of the various characteristic impedances in FIGS. 5, 7 and 9 are about 0.15 mm in the reference 50 Ω system, about 0.063 mm in the 71 Ω system, about 0.28 mm in the 35 Ω system, about 0.38 mm in the 29 Ω system and about 0.64 mm in the 20 Ω system.

As to transmission lines which involve high impedance against the reference 50 Ω, in the case of a thick-film printed board of relatively low cost, since the minimum line width that allows print patterning to be implemented is, normally, 0.1 mm or so, the line width of 0.063 mm for 71 Ω system transmission lines is beyond the limits of general manufacturing technique.

As to transmission lines which involve low impedance against the reference 50 Ω (e.g., 20 Ω system transmission line), wavelength λ has to be involved in the discussion in order to clarify the issues. For example, when use in the milliwave band of 60 GHz is considered, the length of the λ/4 transmission line is around 0.4-0.5 mm. In contrast to this, the line width of, for example, a 20 Ω system transmission line is 0.64 mm. That is, length and width of the transmission lines would be generally equal to each other, resulting in a considerable imbalance. Normally, high-frequency transmission lines such as microstrip lines are designed so as to be sufficiently larger lengthwise than widthwise. This is because sufficiently larger length than width makes it possible to simplify the discussion as a one-dimensional circuit of a single propagation mode. However, when the line width is considerably large as in the 20 Ω system transmission line, the transmission line would operate as a two-dimensional circuit of a plurality of propagation modes, leading to occurrence of unexpected parasitic characteristics.

It is therefore an object of the present invention to provide a feeder circuit for array antennas which allows impedance matching of high-frequency transmission lines to be obtained with a simple circuit construction and which can easily be miniaturized.

In order to achieve the above object, there is provided a feeder circuit for array antennas capable of feeding an electric signal to a plurality of element antennas via high-frequency transmission lines formed on a high-frequency substrate, wherein

the high-frequency transmission lines comprise:

a first high-frequency transmission line having one end thereof connected to at least either one of a transmitting circuit side or a receiving circuit side;

second and third high-frequency transmission lines each having one end thereof connected to the other end of the first high-frequency transmission line so that the other end of the first high-frequency transmission line is bifurcated into two directions, the second and third high-frequency transmission lines each having ¼a length of a wavelength of the electric signal;

fourth and fifth high-frequency transmission lines each having one end thereof connected to the other end of the second high-frequency transmission line so that the other end of the second high-frequency transmission line is bifurcated into two directions, the other ends of the fourth and fifth high-frequency transmission lines being connected to first and second element antennas, respectively; and

sixth and seventh high-frequency transmission lines each having one end thereof connected to the other end of the third high-frequency transmission line so that the other end of the third high-frequency transmission line is bifurcated into two directions, the other ends of the sixth and seventh high-frequency transmission lines being connected to third and fourth element antennas, respectively.

In this feeder circuit for array antennas having the above constitution, the other end of the first high-frequency transmission line having one end thereof connected to at least either one of the transmitting circuit side or the receiving circuit side is bifurcated into two directions by the second and third high-frequency transmission lines each having ¼the length of a wavelength of the electric signal. Further, one end of one bifurcated second high-frequency transmission line is bifurcated into two directions by the fourth and fifth high-frequency transmission lines, while one end of the other third high-frequency transmission line is bifurcated into two directions by the sixth and seventh high-frequency transmission lines. Then, four element antennas are connected to terminal ends of the four fourth to seventh high-frequency transmission lines, respectively. Since the second and third high-frequency transmission lines have ¼ the length of the wavelength of the transferred electric signal, impedance matching of the circuit can be obtained by virtue of the λ/4 matching circuit on condition that the impedances of the first to seventh high-frequency transmission lines are set to optimum values by taking into account the input impedances of the first to fourth element antennas. As a result of this, when the electric signal inputted to one end of the first high-frequency transmission line is distributed to the four element antennas, the reflection phenomenon of the electric signal at the individual branch points is suppressed. Therefore, impedance matching of the high-frequency transmission lines can be obtained with a simple circuit construction, facilitating the miniaturization of the array antenna. Although this feeder circuit for array antennas has been described on a case of transmission in which an electric signal is inputted from the transmitting circuit side to one end of the first high-frequency transmission line, the case is the same also with cases of reception in which an electric signal received by the first to fourth element antennas is transferred to the receiving circuit side via the first to seventh high-frequency transmission lines.

To sum up, the feeder circuit for array antennas according to the present invention allows the impedance-matched circuit to be simplified. Thus, for example, when it is desired to miniaturize the array antenna as a whole by narrowing the intervals of element antennas constituting the array antenna, the invention is more suitable for miniaturization than the complex structure of the prior art.

Further, variations in line width of high-frequency transmission lines constituting the feeder circuit for array antennas can be reduced. For example, given a reference characteristic impedance of 50 Ω, such high-frequency transmission lines extremely different in line width as 100 Ω high-frequency transmission lines and 25 Ω high-frequency transmission lines are not needed. Therefore, in cases where the feeder circuit for array antennas according to the invention is used at, for example, milliwave band, the risk of worse yield that could result from micro-patterning of extremely thin high-frequency transmission lines, or the risk of high-frequency parasitic characteristics that could result from the provision of extremely thick high-frequency transmission lines, can be reduced advantageously.

In one embodiment of the present invention, given that impedance of the first high-frequency transmission line is Z₀ and impedances of the second and third high-frequency transmission lines are Za and Z_{b}, respectively, and given that apparent impedance of the fourth high-frequency transmission line with the first element antenna connected thereto is Z₁, apparent impedance of the fifth high-frequency transmission line with the second element antenna connected thereto is Z₂, apparent impedance of the sixth high-frequency transmission line with the third element antenna connected thereto is Z₃, and that apparent impedance of the seventh high-frequency transmission line with the fourth element antenna connected thereto is Z₄, then a relational expression

$$\frac{1}{{Z}_{0}} = \frac{\frac{{Z}_{1} \times {Z}_{2}}{{Z}_{1} + {Z}_{2}}}{{Z}_{a} \times {Z}_{a}} + \frac{\frac{{Z}_{3} \times {Z}_{4}}{{Z}_{3} + {Z}_{4}}}{{Z}_{b} \times {Z}_{b}} \qquad \text{(Eq. 1)}$$

is satisfied.

A high frequency equivalent circuit of the feeder circuit for array antennas according to this embodiment is shown in FIG. 13. In this feeder circuit for array antennas, impedances of the first to seventh high-frequency transmission lines are determined as follows for a impedance matching purpose. As seen in FIG. 13, an input port is provided on the left side, and right-side four output ports are connected to the first to fourth four element antennas, respectively. In order to derive the conditions for impedance matching of this high frequency equivalent circuit, impedances as viewed toward the output side at four points A, B, C and D in the circuit are computed one by one. For this operation, applying the relational expression for the λ/4 matching circuit shown in FIG. 11 and the high frequency circuit theory allows the impedances to be easily determined as follows:

The impedance viewed from A to the output side is:

(Z₁×Z₂)/(Z₁+Z₂)

The impedance viewed from B to the output side is:

(Z₃×Z₄)/(Z₃+Z₄)

The impedance viewed from C to the output side is:

{(Z₁+Z₂)/(Z₁×Z₂)}×(Zₐ×Zₐ); and

The impedance viewed from D to the output side is:

{(Z₃+Z₄)/(Z₃×Z₄)}×(Z_{b}×Z_{b})

Therefore, impedance matching of the circuit at a point E on the input port side can be obtained if the relation of Equation 1 holds. Hence, according to the feeder circuit for array antennas of this embodiment, impedance matching of the circuit can surely be obtained by satisfying the relation of Equation 1.

In one embodiment of the present invention, the impedances Z₀, Zₐ, Z_{b}, Z₁, Z₂, Z₃ and Z₄ satisfy a condition of:

Z₀=Zₐ=Z_{b}=Z₁=Z₂=Z₃=Z₄=50 Ω.

According to the feeder circuit for array antennas of this embodiment, for array antennas without weighting being applied for side lobe suppression, a simplified, superior design of the circuit free from variations in line width of the high-frequency transmission lines can be achieved, in particular, by setting that Z₀=Z₁=Z₂=Z₃=Z₄=Zₐ=Z_{b}50=Ω.

In one embodiment of the present invention, the impedances Z₀, Zₐ, Z_{b}, Z₁, Z_{2, Z}₃ and Z₄ satisfy conditions of:

Z₀=Zₐ=Z₁=Z₃=50 Ω;

Z_{b}=35 Ω; and

Z₂=Z₄=25 Ω.

According to the feeder circuit for array antennas of this embodiment, for array antennas to which weighting for side lobe suppression is applied, when a current is distributed to the four element antennas at a ratio of 1:2:2:4 as a particularly easy-to-design power distribution ratio, setting that Z₀=Zₐ=Z₁=Z₃=50 Ω, Z_{b}=35 Ω, and Z₂=Z₄=25 Ω makes it possible to achieve a simplified, superior design with less variations in line width of the transmission lines.

Further, in cases where the feeder circuit for array antennas according to the invention is applied to high-frequency radio communication devices or high-frequency radar devices, given that the number of element antennas remain the same, the area of the array antenna can be made smaller than the conventional counterpart, so that the device as a whole can be miniaturized and, moreover, given that the area of the array antenna remains the same, the number of element antennas can be increased over the conventional counterpart, so that the reception sensitivity of the device as a whole can be improved.

There is provided a high-frequency radio communication device which uses the above feeder circuit for array antennas.

According to the high-frequency radio communication device of this constitution, by simplifying the construction of the array antenna, the device as a whole can be miniaturized, and transmission gain and reception sensitivity can be improved.

Also, there is provided a high-frequency radar device which uses the above feeder circuit for array antennas.

According to the high-frequency radar device of this constitution, by simplifying the construction of the array antenna, the device as a whole can be miniaturized, and transmission gain can be improved.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a plan view of a feeder circuit for array antennas (without weighting) according to a first embodiment of the present invention;

FIG. 2 is a high frequency equivalent circuit of the feeder circuit for array antennas;

FIG. 3 is a plan view of a feeder circuit for array antennas (with weighting applied) according to a second embodiment of the present invention;

FIG. 4 is a high frequency equivalent circuit of the feeder circuit for array antennas;

FIG. 5 is a plan view of a feeder circuit for array antennas (without weighting) according to the prior art;

FIG. 6 is a high frequency equivalent circuit of the feeder circuit for array antennas;

FIG. 7 is a plan view of a feeder circuit for array antennas (without weighting) according to the prior art;

FIG. 8 is a high frequency equivalent circuit of the feeder circuit for array antennas;

FIG. 9 is a plan view of a feeder circuit for array antennas (with weighting applied) according to the prior art;

FIG. 10 is a high frequency equivalent circuit of the feeder circuit for array antennas;

FIG. 11 is a schematic view of a λ/4 matching circuit;

FIG. 12 is a view showing the construction of a large-scale array antenna; and

FIG. 13 is a high frequency equivalent circuit for explaining the principle of the present invention.

### DETAILED DESCRIPTION OF THE PREFERRED EMBODIMENTS

Hereinbelow, the feeder circuit for array antennas according to the present invention is described in more detail by way of embodiments thereof illustrated in the accompanying drawings.

(First Embodiment)

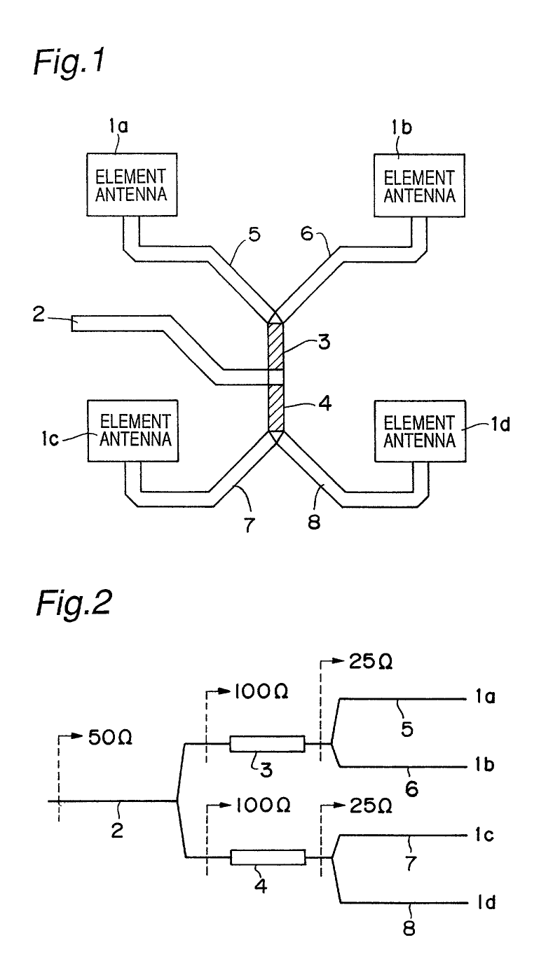

FIG. 1 is a plan view of a feeder circuit for array antennas according to a first embodiment of the invention. It is noted that λ is the wavelength of an electric signal which propagates along the microstrip line at the operating frequency of the array antenna.

Referring to FIG. 1, reference numerals 1a-1d denote four element antennas disposed at quadrilateral corners, respectively, 2 denotes a transmission line as a first high-frequency transmission line to one end of which an electric signal from the transmitting circuit side is to be inputted, 3 denotes a λ/4 transmission line (hatched portion in FIG. 1) as a second high-frequency transmission line whose one end is connected to the other end of the transmission line 2, 4 denotes a λ/4 transmission line (hatched portion in FIG. 1) as a third high-frequency transmission line whose one end is connected to the other end of the transmission line 2, 5 denotes a transmission line as a fourth high-frequency transmission line one end of which is connected to the other end of the λ/4 transmission line 3 and to the other end of which the element antenna 1a is connected, 6 denotes a transmission line as a fifth high-frequency transmission line one end of which is connected to the other end of the λ/4 transmission line 3 and to the other end of which the element antenna 1b is connected, 7 denotes a transmission line as a sixth high-frequency transmission line one end of which is connected to the other end of the λ/4 transmission line 4 and to the other end of which the element antenna 1c is connected, and 8 denotes a transmission line as a seventh high-frequency transmission line one end of which is connected to the other end of the λ/4 transmission line 4 and to the other end of which the element antenna 1d is connected. The transmission line 2 is bifurcated into two directions by the λ/4 transmission lines 3, 4, the λ/4 transmission line 3 is bifurcated into two directions by the transmission lines 5, 6, and the λ/4 transmission line 4 is bifurcated into two directions by the transmission lines 7, 8. In this first embodiment, weighting for side lobe suppression is not applied.

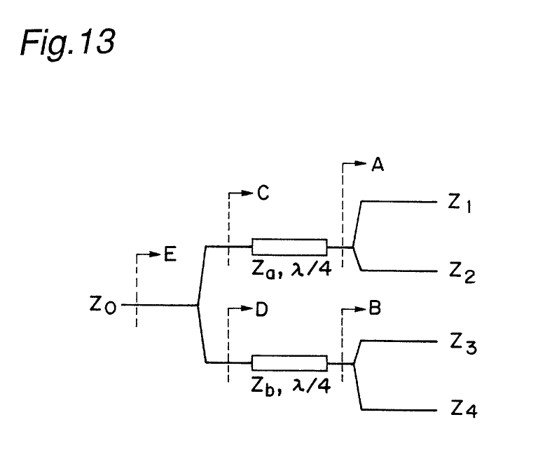

The feeder circuit composed of the element antennas 1a, 1b, 1c, 1d and the transmission lines 2-8 is integrally formed on a ceramic substrate (not shown) having a dielectric constant of 9.8 by print patterning with 20 μm thick copper paste. All the transmission lines 2-8 are implemented by microstrip lines of a 50 Ω impedance system, their line widths being 0.15 mm. The four element antennas 1a, 1b, 1c, 1d are implemented by patch antennas. An electric signal inputted to one end of the transmission line 2 is distributed through totally three bifurcated places, and then fed to the element antennas 1a, 1b, 1c, 1d at generally equal amplitude and in phase. In this first embodiment, the high frequency equivalent circuit of FIG. 13 satisfies the following relational expression:

$$\frac{1}{{Z}_{0}} = \frac{\frac{{Z}_{1} \times {Z}_{2}}{{Z}_{1} + {Z}_{2}}}{{Z}_{a} \times {Z}_{a}} + \frac{\frac{{Z}_{3} \times {Z}_{4}}{{Z}_{3} + {Z}_{4}}}{{Z}_{b} \times {Z}_{b}} \qquad \text{(Eq. 1)}$$

and moreover is designed to satisfy the following equation:

Z₀Z₁=Z₂=Z₃=Z₄=Zₐ=Z_{b}=50 Ω.

As a result of designing for use at 60 GHz band in FIG. 1, the λ/4 transmission lines 3, 4 are about 0.47 mm long. These λ/4 transmission lines 3, 4 of the 50 Ω system are inserted at totally two places for the purpose of impedance matching.

FIG. 2 is a high frequency equivalent circuit of the feeder circuit for array antennas shown in FIG. 1. At a plurality of points in the circuit, impedances as viewed toward the element antennas 1a, 1b, 1c, 1d are expressed by dotted lines, arrows and numerical values. For an easier confirmation from the high frequency circuit theory, this feeder circuit is impedance-matched with the 50 Ω system.

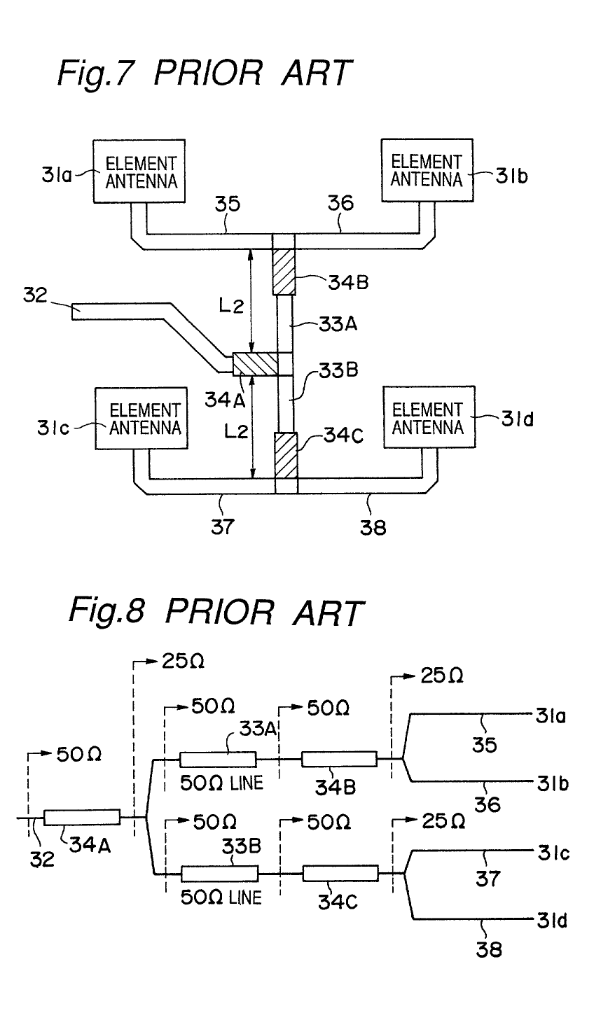

Like this, the feeder circuit for array antennas allows the circuit to be remarkably simplified, compared with FIGS. 5 and 7 of the prior art having similar functions. Therefore, according to the feeder circuit for array antennas of this invention, impedance matching of high-frequency transmission lines can be obtained with a simple circuit construction, making it easy to miniaturize the feeder circuit for array antennas.

Further, by setting the characteristic impedances of the individual transmission lines 2-8 so that the relational expression of Equation 1 is satisfied, impedance matching of the circuit can surely be obtained and moreover a simplified superior design without variations in line width of the transmission lines can be implemented.

(Second Embodiment)

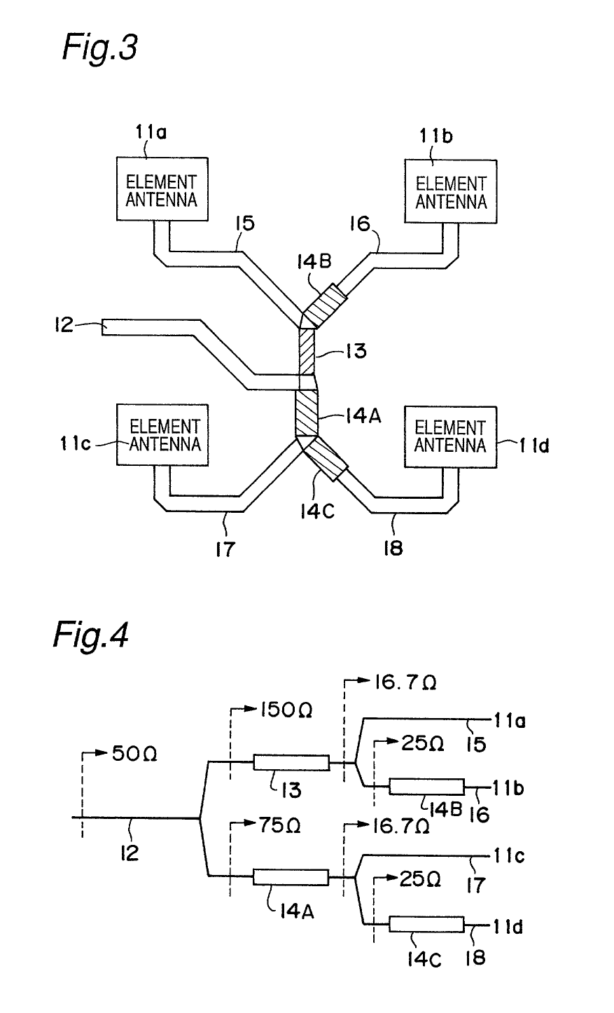

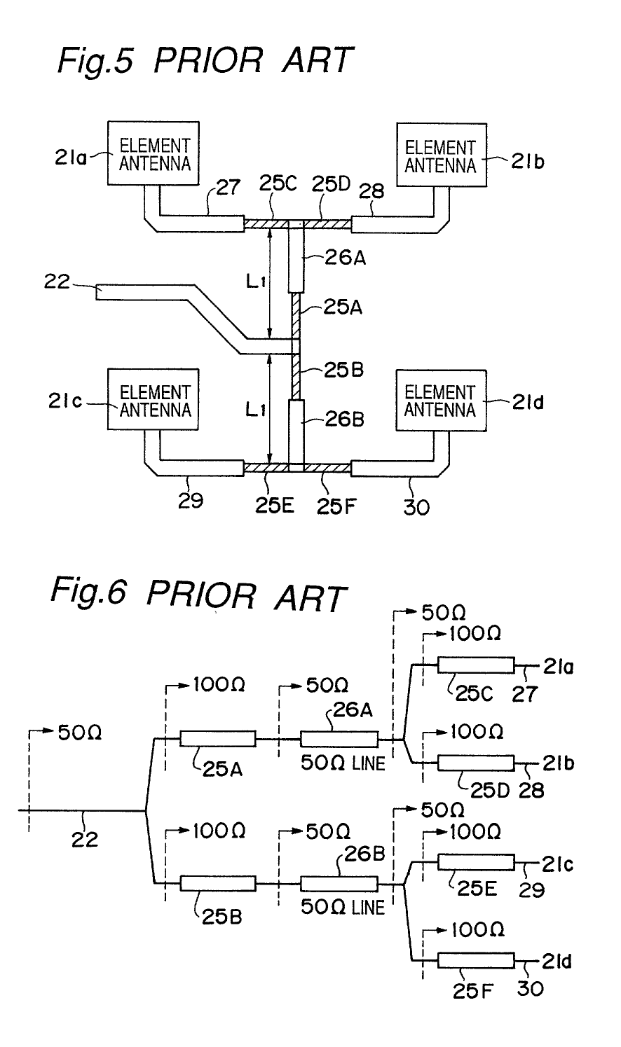

FIG. 3 is a plan view of a feeder circuit for array antennas according to a second embodiment of the present invention. In this feeder circuit for array antennas, weighting for side lobe suppression is applied.

Referring to FIG. 3, reference numerals 11a-11d denote four element antennas disposed at quadrilateral corners, respectively, 12 denotes a transmission line as a first high-frequency transmission line to one end of which an electric signal from the transmitting circuit side is to be inputted, 13 (hatched portion in FIG. 3) denotes a λ/4 transmission line as a second high-frequency transmission line whose one end is connected to the other end of the first transmission line 12, 14A denotes a λ/4 transmission line (hatched portion in FIG. 3) as a third high-frequency transmission line whose one end is connected to the other end of the first transmission line 12, 15 denotes a transmission line as a fourth high-frequency transmission line one end of which is connected to the other end of the λ/4 transmission line 13 and to the other end of which the element antenna 11a is connected, 16 denotes a transmission line one end of which is connected to the other end of the λ/4 transmission line 13 via a λ/4 transmission line 14B (hatched portion in FIG. 3) and to the other end of which the element antenna 11b is connected, 17 denotes a transmission line as a sixth high-frequency transmission line one end of which is connected to the other end of the λ/4 transmission line 14A and to the other end of which the element antenna 11c is connected, and 18 denotes a transmission line one end of which is connected to the other end of the λ/4 transmission line 14A (hatched portion in FIG. 3) via a λ/4 transmission line 14C and to the other end of which the element antenna lid is connected. The λ/4 transmission line 14B and the transmission line 16 constitute a fifth high-frequency transmission line, and the λ/4 transmission line 14C and the transmission line 18 constitute a seventh high-frequency transmission line.

In this feeder circuit for array antennas, as a result of using the same substrate material as in the feeder circuit for array antennas of FIG. 1 of the first embodiment, the line width of the 35 Ω transmission lines 14 is about 0.28 mm.

In FIG. 13, Z₂ and Z₄ are set substantially to 25 Ω by the following manner. Connecting a λ/4 transmission line to an end of a 50 Ω transmission line allows 25 Ω to be substantially obtained. That is, the circuit of FIG. 13 is so designed that the relational expression of Equation 1 holds as in the first embodiment, and that the following equation holds: Z₀=Zₐ=Z₁=Z₃=50 Ω,

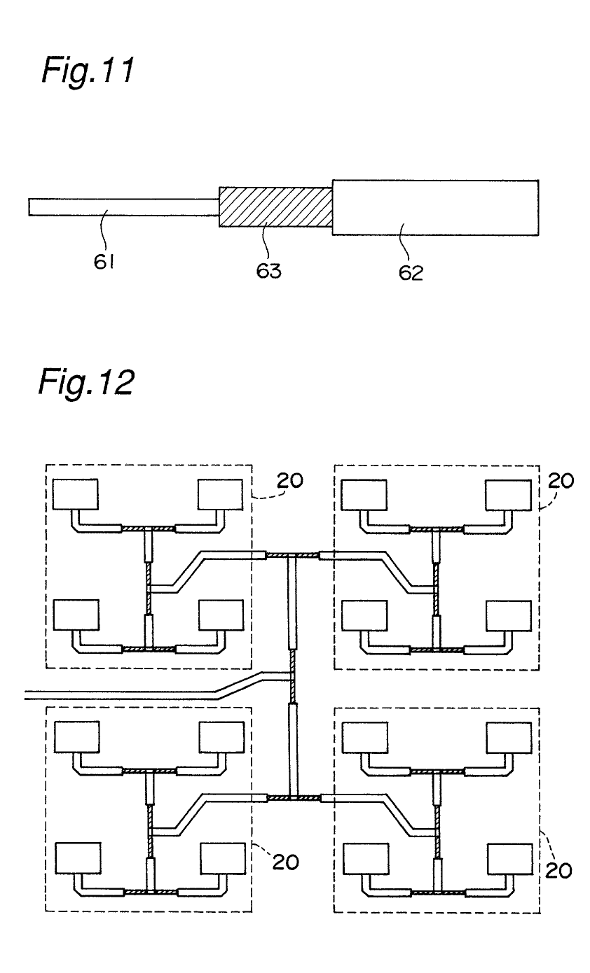

by which Z₂ and Z₄ are set substantially to 25 Ω. Explaining this by using FIG. 11, even if Z₁₂=50 Ω, setting that Z₁₃=35 Ω allows impedance matching to be obtained against Z₁₂=25 Ω.

FIG. 4 is a high frequency equivalent circuit of the feeder circuit for array antennas shown in FIG. 3. At a plurality of points in the circuit, impedances as viewed toward the element antennas 11a, 11b, 11c, 11d are expressed by dotted lines, arrows and numerical values. For an easier confirmation from the high frequency circuit theory, this feeder circuit for array antennas is impedance-matched with the 50 Ω system.

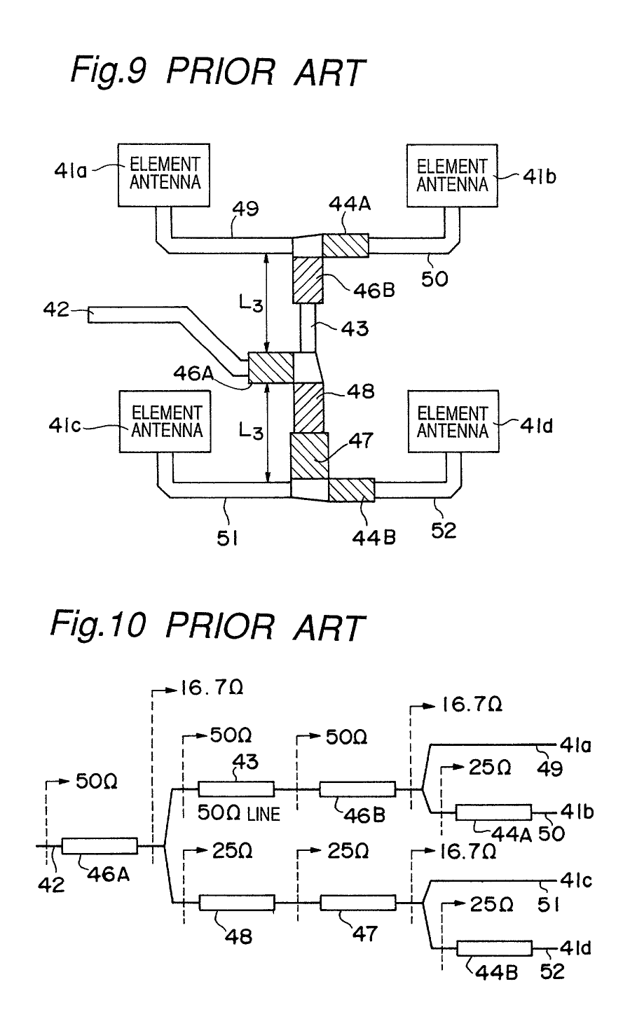

Like this, the feeder circuit for array antennas allows the circuit to be remarkably simplified and further allows variations in line width of the transmission lines to be reduced, compared with FIG. 9 of the prior art having similar functions. Therefore, according to this feeder circuit for array antennas, impedance matching of high-frequency transmission lines can be obtained with a simple circuit construction, making it easy to miniaturize the feeder circuit for array antennas.

Further, by setting the characteristic impedances of the individual transmission lines 12, 13, 14A, 14B, 14C, 15-18 so that the relational expression of Equation 1 is satisfied, impedance matching of the circuit can surely be obtained.

Also, in the feeder circuit for array antennas to which weighting for side lobe suppression is applied, setting that Z₀=Zₐ=Z₁=Z₃=50 Ω, Z_{b}=35 Ω, and Z₂=Z₄=25 Ω allows currents to be distributed to the four element antennas 11a-11d at a ratio of 1:2:2:4 as a power distribution ratio. This makes it possible to implement a simplified, superior design for the feeder circuit for array antennas with less variations in line width of the transmission lines.

The first and second embodiments have been described on a feeder circuit for array antennas in which the number of element antennas is 4 (=2×2). However, the present invention may be applied to feeder circuits for larger-scale array antennas.

The first and second embodiments have been described on a feeder circuit for array antennas in which the input impedances of element antennas are of the 50 Ω system. However, according to the gist of the invention, the invention may be applied also to cases in which the input impedances of element antennas are of the 100 Ω system in a similar manner.

The second embodiment has been described, for the case where weighting for side lobe suppression is applied, on a case where the current distribution to the individual element antennas 11a-11d is the simplest ratio of 1:2:2:4. However, according to the gist of the invention, the invention may be applied also to cases of different distribution ratios.

The first and second embodiments have been described on a feeder circuit for an array antenna for transmission use that distributes and feeds an electric signal. However, the invention may be applied also to feeder circuits for array antennas for reception use or to feeder circuits for array antennas for transmission and reception use.

When the feeder circuits for array antennas of the first and second embodiments are used for high-frequency radio communication devices or high-frequency radar devices, the area of the array antenna can be reduced and, moreover, the number of element antennas can be increased, while the array antenna remains the same area, so that transmission gain or reception sensitivity is enhanced.

Further, the first and second embodiments have been described on feeder circuits for array antennas in which microstrip lines are used as high-frequency transmission lines. However, the high-frequency transmission lines are not limited to these, and the invention may also be applied to feeder circuits for array antennas using coplanar lines formed on a high-frequency substrate.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A feeder circuit for array antennas capable of feeding an electric signal to a plurality of element antennas via high-frequency transmission lines formed on a high-frequency substrate, wherein
the high-frequency transmission lines comprise:
a first high-frequency transmission line having one end thereof connected to at least either one of a transmitting circuit side or a receiving circuit side;
second and third high-frequency transmission lines each having one end thereof connected to the other end of the first high-frequency transmission line so that the other end of the first high-frequency transmission line is bifurcated into two directions, the second and third high-frequency transmission lines each having ¼a length of a wavelength of the electric signal;
fourth and fifth high-frequency transmission lines each having one end thereof connected to the other end of the second high-frequency transmission line so that the other end of the second high-frequency transmission line is bifurcated into two directions, the other ends of the fourth and fifth high-frequency transmission lines being connected to first and second element antennas, respectively; and
sixth and seventh high-frequency transmission lines each having one end thereof connected to the other end of the third high-frequency transmission line so that the other end of the third high-frequency transmission line is bifurcated into two directions, the other ends of the sixth and seventh high-frequency transmission lines being connected to third and fourth element antennas, respectively.

2. The feeder circuit for array antennas according to claim 1, wherein
given that impedance of the first high-frequency transmission line is Z₀ and impedances of the second and third high-frequency transmission lines are Za and Z_{b}, respectively, and given that apparent impedance of the fourth high-frequency transmission line with the first element antenna connected thereto is Z₁, apparent impedance of the fifth high-frequency transmission line with the second element antenna connected thereto is Z₂, apparent impedance of the sixth high-frequency transmission line with the third element antenna connected thereto is Z₃, and that apparent impedance of the seventh high-frequency transmission line with the fourth element antenna connected thereto is Z₄, then a relational expression
$$\frac{1}{{Z}_{0}} = \frac{\frac{{Z}_{1} \times {Z}_{2}}{{Z}_{1} + {Z}_{2}}}{{Z}_{a} \times {Z}_{a}} + \frac{\frac{{Z}_{3} \times {Z}_{4}}{{Z}_{3} + {Z}_{4}}}{{Z}_{b} \times {Z}_{b}} \qquad \text{(Eq. 1)}$$
is satisfied.

3. The feeder circuit for array antennas according to claim 2, wherein
the impedances Z₀, Zₐ, Z_{b}, Z₁, Z₂, Z₃ and Z₄ satisfy a condition of:
Z₀=Zₐ=Z_{b}=Z₁=Z₂=Z₃=Z₄=50 Ω.

4. The feeder circuit for array antennas according to claim 2, wherein
the impedances Z₀, Zₐ, Z_{b}, Z₁, Z₂, Z₃ and Z₄ satisfy conditions of:
Z₀=Zₐ=Z₁=Z₃=50 Ω;
Z_{b}=35 Ω; and
Z₂=Z₄=25 Ω.

5. A high-frequency radio communication device which uses the feeder circuit for array antennas as defined in claim 1.

6. A high-frequency radar device which uses the feeder circuit for array antennas as defined in claim 1.
